(19) United States
(12) Patent Application Publication
(10) Pub. No.: US 2024/0040436 A1
(43) Pub. Date: Feb. 1, 2024

(54) DATA PROCESSING APPARATUS, DATA PROCESSING METHOD, AND DATA PROCESSING PROGRAM

(71) Applicant: NIPPON TELEGRAPH AND TELEPHONE CORPORATION, Tokyo (JP)

(72) Inventors: Shoko SHINOHARA, Musashino-shi (JP); Yasuhiko INOUE, Musashino-shi (JP); Yusuke ASAI, Musashino-shi (JP); Yasushi TAKATORI, Musashino-shi (JP)

(73) Assignee: NIPPON TELEGRAPH AND TELEPHONE CORPORATION, Tokyo (JP)

(21) Appl. No.: 18/268,602

(22) PCT Filed: Dec. 25, 2020
(86) PCT No.: PCT/JP2020/048619

§ 371 Date: Jun. 20, 2023

(51) Int. Cl. H04W 28/20; H04L 5/00

(52) U.S. Cl. CPC H04W 28/20; H04L 5/0039; H04L 5/0048

(57) ABSTRACT

A data processing apparatus according to an embodiment includes a signal processing unit and a control unit. The signal processing unit is configured to receive data wirelessly transmitted from the terminal apparatus. The control unit executes a first operation under a constraint condition related to wireless communication of the terminal apparatus. The first operation includes: determining a transmission control parameter used for wireless communication of the terminal apparatus; and repeatedly determining a transmission control parameter again using the determined transmission control parameter when the determined transmission control parameter is different from the transmission control parameter before the determination. The control unit is configured to apply the transmission control parameter obtained through the first operation to the terminal apparatus.

### TECHNICAL FIELD

The embodiment relates to a data processing apparatus, a data processing method, and a data processing program.

### BACKGROUND ART

A wireless local area network (LAN) is known as an information communication system that wirelessly connects a base station and a terminal.

### CITATION LIST

### Non Patent Literature

Non Patent Literature 1: ARIB STD-T 108 version 1.3, “Wireless Equipment Standards for 920 MHz Band Telemeter, Telecontrol and Data Transmission, 3.4 Control Device”, Apr. 12, 2019 Non Patent Literature 2: IEEE Std 802.11ah TM-2016 (IEEE Standard for Information technology—Telecommunications and information exchange between systems Local and metropolitan area networks—Specific requirements, Part 11: Wireless LAN Medium Access Control (MAC) and Physical Layer (PHY) Specifications, Amendment 2: Sub 1 GHz License Exempt Operation, IEEE Computer Society, 7 Dec. 2016

### SUMMARY OF INVENTION

### Technical Problem

A problem is to implement stable wireless communication in a wireless communication system.

### Means for Solution to Problem

A data processing apparatus according to an embodiment includes a signal processing unit and a control unit. The signal processing unit is configured to be able to receive data wirelessly transmitted from the terminal apparatus. The control unit executes the first operation under a constraint condition related to wireless communication of the terminal apparatus. The first operation includes: determining a transmission control parameter used for wireless communication of the terminal apparatus; and repeatedly determining a transmission control parameter again using the determined transmission control parameter when the determined transmission control parameter is different from the transmission control parameter before the determination. The control unit is configured to be able to apply the transmission control parameter obtained through the first operation to the terminal apparatus.

### Advantageous Effects of Invention

The data processing apparatus of the embodiment can implement stable wireless communication in a wireless communication system.

### BRIEF DESCRIPTION OF DRAWINGS

FIG. 1 is a conceptual diagram illustrating an example of an overall configuration of a wireless communication system according to a first embodiment.

FIG. 2 is a conceptual diagram illustrating an example of a frequency band used for wireless communication in the wireless communication system according to the first embodiment.

FIG. 3 is a block diagram illustrating an example of a hardware configuration of a data processing apparatus included in the wireless communication system according to the first embodiment.

FIG. 4 is a block diagram illustrating an example of a hardware configuration of a base station included in the wireless communication system according to the first embodiment.

FIG. 5 is a block diagram illustrating an example of a hardware configuration of a terminal apparatus included in the wireless communication system according to the first embodiment.

FIG. 6 is a block diagram illustrating an example of a functional configuration of a data processing apparatus included in the wireless communication system according to the first embodiment.

FIG. 7 is a block diagram illustrating an example of a functional configuration of a base station included in the wireless communication system according to the first embodiment.

FIG. 8 is a block diagram illustrating an example of a functional configuration of a terminal apparatus included in the wireless communication system according to the first embodiment.

FIG. 9 is a flowchart illustrating an example of a communication management operation in the wireless communication system according to the first embodiment.

FIG. 10 is a time chart illustrating an example of a communication management operation in the wireless communication system according to the first embodiment.

FIG. 11 is a flowchart illustrating an example of a parameter calculation operation in the data processing apparatus included in the wireless communication system according to the first embodiment.

FIG. 12 is a flowchart illustrating a parameter calculation operation according to a comparative example.

FIG. 13 is a conceptual diagram illustrating an example of an overall configuration of a wireless communication system according to a modification of the first embodiment.

FIG. 14 is a conceptual diagram illustrating an example of an overall configuration of a wireless communication system according to a second embodiment.

FIG. 15 is a block diagram illustrating an example of a hardware configuration of a satellite base station included in a wireless communication system according to the second embodiment.

FIG. 16 is a block diagram illustrating an example of a functional configuration of a satellite base station included in a wireless communication system according to the second embodiment.

FIG. 17 is a time chart illustrating an example of a communication management operation in the wireless communication system according to the second embodiment.

FIG. 18 is a flowchart illustrating an example of a parameter calculation operation in the data processing apparatus included in the wireless communication system according to the second embodiment.

### DESCRIPTION OF EMBODIMENTS

Hereinafter, each embodiment will be described with reference to the drawings. Each embodiment exemplifies an apparatus and a method for embodying the technical idea of the invention. The drawings are schematic or conceptual. Dimensions, ratios, and the like of each drawing are not necessarily the same as actual ones. The technical idea of the present invention is not specified by shapes, structures, arrangements, and the like of constituent elements. In the following description, components that have substantially the same functions and configurations are denoted by the same reference numerals. Letters following the numbers in the reference numerals are used to distinguish between elements referred to by reference numerals including the same numerals and having similar configurations. Where elements denoted by reference numerals containing the same number do not need to be distinguished from one another, these elements are referred to by reference numerals containing only numbers.

### <1> First Embodiment

A wireless communication system 1 according to a first embodiment will be described.

<1-1> Configuration

<1-1-1> Overall Configuration of Wireless Communication System 1

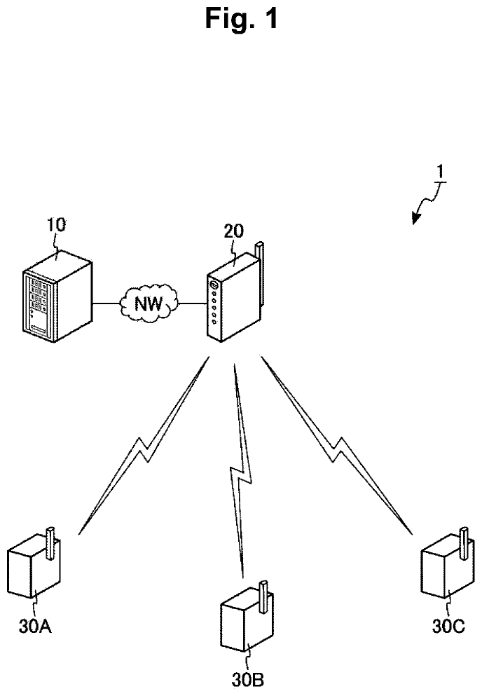

FIG. 1 is a conceptual diagram illustrating an example of an overall configuration of the wireless communication system 1 according to the first embodiment. As illustrated in FIG. 1, the wireless communication system 1 according to the first embodiment includes a data processing apparatus 10, a base station 20, and a terminal apparatus 30.

The data processing apparatus 10 is a computer configured to be connectable to the network NW. The data processing apparatus 10 can control an apparatus belonging to the wireless communication system 1. The base station 20 and at least one terminal apparatus 30 wirelessly connected to the base station 20 belong to the data processing apparatus 10. The data processing apparatus 10 stores, for example, data transferred from the terminal apparatus 30 via the base station 20. When the data processing apparatus 10 ascertains the terminal apparatus 30 belonging to the wireless communication system 1, it is possible to collect information from the terminal apparatus 30 and control the terminal apparatus 30. Communication between the data processing apparatus 10 and the base station 20 may be wireless or a combination of wireless communication and wired communication.

The base station 20 is a wireless LAN access point or a wireless LAN router configured to be connectable to the network NW. The base station 20 can transmit and receive data to and from the data processing apparatus 10 via the network NW. The base station 20 is configured to be able to wirelessly communicate with one or more terminal apparatuses TA using one type of frequency band or a plurality of types of frequency bands. The base station may be wirelessly connected to a wireless relay apparatus (in other words, a wireless range extender, a relay station, a repeater) or may be wirelessly connected to both the terminal apparatus 30 and the wireless relay apparatus.

The terminal apparatus 30 is a computer configured to be able to wirelessly communicate with the base station 20. For example, the terminal apparatus 30 is an Internet of Things (IoT) apparatus capable of acquiring information around the terminal apparatus 30. Examples of the IoT apparatus include a monitoring camera, a sensor apparatus, and a remote management apparatus. Such a terminal apparatus 30 has a function of transferring acquired information (data) to the data processing apparatus 10 via the base station 20. In this example, three terminal apparatuses 30A, 30B, and 30C are wirelessly connected to the base station 20.

The wireless communication system 1 according to the first embodiment may have other configurations. For example, the number of terminal apparatuses 30 belonging to the wireless communication system 1 can be designed to any number within a range of the performance of each of the data processing apparatus 10 and the base station 20. The base station 20 may have a function of the data processing apparatus 10. When the base station 20 has the function of the data processing apparatus 10, the data processing apparatus 10 may be omitted from the wireless communication system 1.

(Frequency Band Used by Wireless Communication System 1)

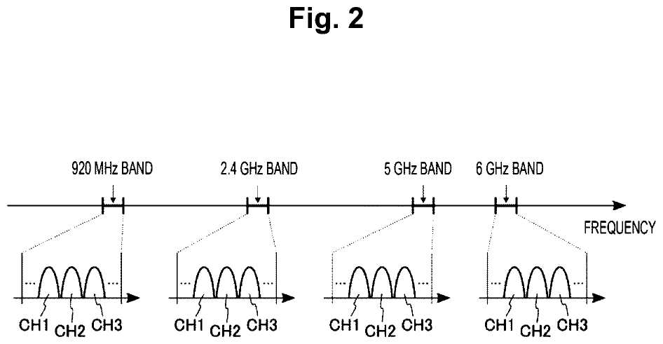

FIG. 2 is a conceptual diagram illustrating an example of a frequency band that can be used for wireless communication in the wireless communication system 1 according to the first embodiment. As illustrated in FIG. 2, wireless communication between the base station 20 and the terminal apparatus 30 can use radio waves in any frequency band of a 920 MHz band, a 2.4 GHz band, a 5 GHz band, and a 6 GHz band. Each frequency band includes a plurality of channels. Specifically, the 920 MHz band, the 2.4 GHz band, the 5 GHz band, and the 6 GHz band each include three channels CH1, CH2, and CH3.

A frequency band other than the 920 MHz band, the 2.4 GHz band, the 5 GHz band, and the 6 GHz band may be used for wireless communication between the base station 20 and the terminal apparatus 30. At least one channel CH may be allocated to each frequency band. In the wireless communication between the base station 20 and the terminal apparatus 30, one type of frequency band may be used or a plurality of types of frequency bands may be used. When the plurality of terminal apparatuses 30 are wirelessly connected to the base station 20, channels CH of different frequency bands may be used.

<1-1-2> Hardware Configuration of Wireless Communication System 1

Hereinafter, an example of a hardware configuration of each of the data processing apparatus 10, the base station 20, and the terminal apparatus 30 in the wireless communication system 1 according to the first embodiment will be sequentially described.

(Hardware Configuration of Data Processing Apparatus 10)

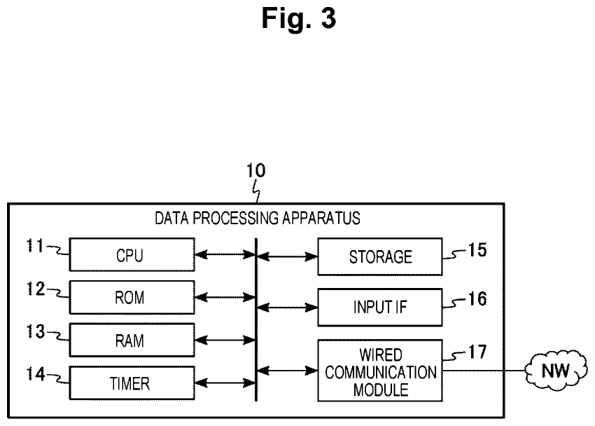

FIG. 3 is a block diagram illustrating an example of a hardware configuration of the data processing apparatus 10 included in the wireless communication system 1 according to the first embodiment. As illustrated in FIG. 3, the data processing apparatus 10 includes, for example, a central processing unit (CPU) 11, a read-only memory (ROM) 12, a random access memory (RAM) 13, a timer 14, a storage 15, an input interface (IF) 16, and a wired communication module 17.

The CPU 11 is an integrated circuit capable of executing various programs. The CPU 11 controls the entire operation of the data processing apparatus 10.

The ROM 12 is a nonvolatile semiconductor memory. The ROM 12 stores a program controlling the data processing apparatus 10, control data, and the like.

The RAM 13 is, for example, a volatile semiconductor memory. The RAM 13 is used as a working area of the CPU 11.

The timer 14 is a clock used to manage time. The timer 14 is used, for example, as a trigger for executing a communication management operation to be described below.

The storage 15 is a nonvolatile storage device. The storage 15 stores, for example, system software of the data processing apparatus 10, data acquired via the network NW, and the like.

The input interface 16 is an input device such as a keyboard. The input interface 16 is used to input information to software executed by the data processing apparatus 10.

The wired communication module 17 is a circuit used to transmit and receive data by a wired signal. The wired communication module 17 is configured to be connectable to the network NW.

The data processing apparatus 10 may have another hardware configuration. For example, the input interface 16 may be externally connected to the data processing apparatus 10. When the input interface 16 is externally connected, the input interface 16 may be connected to the data processing apparatus 10 in a wired manner or in a wireless manner. When the data processing apparatus 10 is wirelessly connected to the network NW, the wired communication module 17 may be omitted from the data processing apparatus 10.

(Hardware Configuration of Base Station 20)

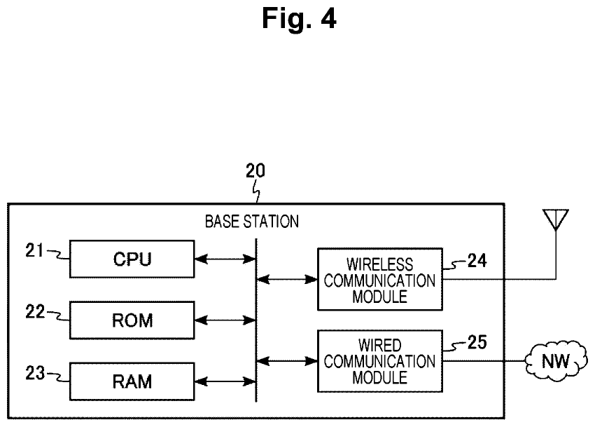

FIG. 4 is a block diagram illustrating an example of a hardware configuration of the base station 20 included in the wireless communication system 1 according to the first embodiment. As illustrated in FIG. 4, the base station 20 includes, for example, a CPU 21, a ROM 22, a RAM 23, a wireless communication module 24, and a wired communication module 25.

The CPU 21 is an integrated circuit capable of executing various programs. The CPU 21 controls the entire operation of the base station 20.

The ROM 22 is a nonvolatile semiconductor memory. The ROM 22 stores a program that controls the base station 20, control data, and the like.

The RAM 23 is, for example, a volatile semiconductor memory. The RAM 23 is used as a working area of the CPU 21.

The wireless communication module 24 is a circuit used to transmit and receive data by a wireless signal. The wireless communication module 24 is configured to be connectable to an antenna and may include a plurality of communication modules respectively corresponding to a plurality of frequency bands.

The wired communication module 25 is a circuit used to transmit and receive data according to a wired signal. The wired communication module 25 is configured to be connectable to the network NW.

The base station 20 may have another hardware configuration. For example, when the base station 20 is wirelessly connected to the network NW, the wired communication module 25 may be omitted from the base station 20.

(Hardware Configuration of Terminal Apparatus 30)

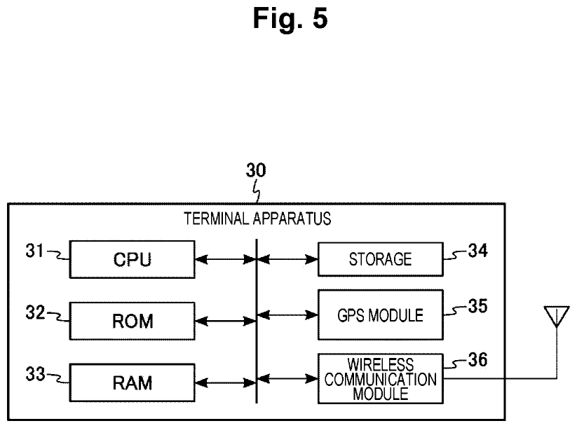

FIG. 5 is a block diagram illustrating an example of a hardware configuration of the terminal apparatus 30 included in the wireless communication system 1 according to the first embodiment. As illustrated in FIG. 5, the terminal apparatus 30 includes, for example, a CPU 31, a ROM 32, a RAM 33, a storage 34, a Global Positioning System (GPS) module 35, and a wireless communication module 36.

The CPU 31 is an integrated circuit capable of executing various programs. The CPU 31 controls the entire operation of the terminal apparatus 30.

The ROM 32 is a nonvolatile semiconductor memory. The ROM 32 stores programs, control data, and the like for controlling the terminal apparatus 30.

The RAM 33 is, for example, a volatile semiconductor memory. The RAM 33 is used as a working area of the CPU 31.

The storage 34 is a nonvolatile storage device. The storage 34 stores, for example, system software of the terminal apparatus 30, data acquired by the terminal apparatus 30, and the like.

The GPS module 35 is a circuit capable of receiving radio waves from GPS satellites and acquiring position data of the terminal apparatus 30.

The wireless communication module 36 is a circuit used to transmit and receive data according to a wireless signal. The wireless communication module 36 is configured to be connectable to an antenna and may include a plurality of communication modules respectively corresponding to a plurality of frequency bands.

The terminal apparatus 30 may have another hardware configuration. For example, when the wireless communication system 1 does not use the positional information of the terminal apparatus 30, the GPS module 35 may be omitted from the terminal apparatus 30.

<1-1-3> Functional Configuration of Wireless Communication System 1

Hereinafter, an example of a functional configuration of each of the data processing apparatus 10, the base station 20, and the terminal apparatus 30 in the wireless communication system 1 according to the first embodiment will be sequentially described.

(Functional Configuration of Data Processing Apparatus 10)

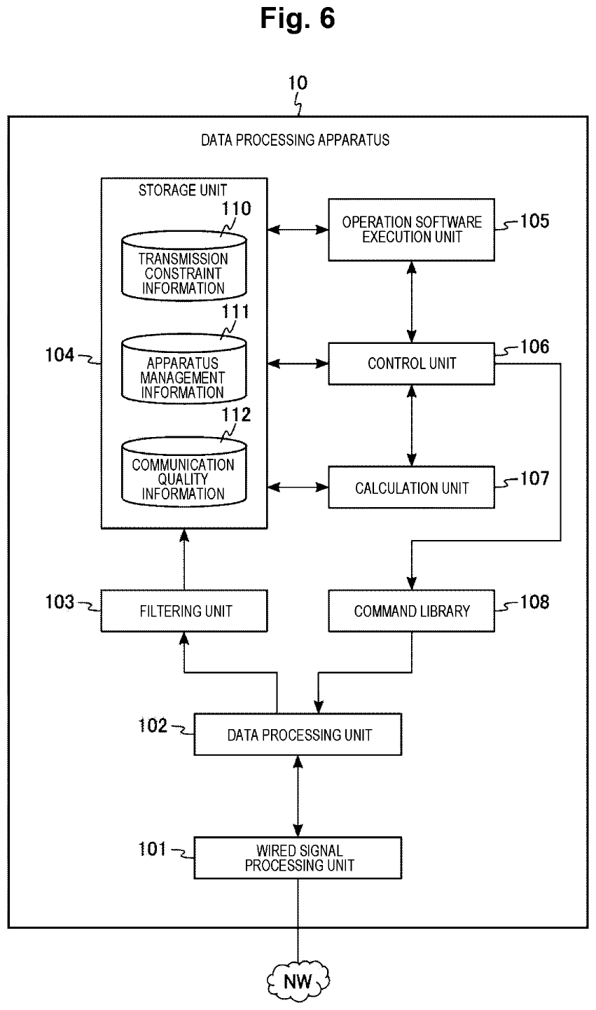

FIG. 6 is a block diagram illustrating an example of a functional configuration of the data processing apparatus 10 included in the wireless communication system 1 according to the first embodiment. As illustrated in FIG. 6, the data processing apparatus 10 includes, for example, a wired signal processing unit 101, a data processing unit 102, a filtering unit 103, a storage unit 104, an operation software execution unit 105, a control unit 106, a calculation unit 107, and a command library 108.

The wired signal processing unit 101 handles data communication via the network NW based on Transmission Control Protocol/Internet Protocol (TCP/IP). The wired signal processing unit 101 inputs a frame received from the base station 20 via the network NW to the data processing unit 102. The wired signal processing unit 101 transmits the frame input from the data processing unit 102 to the base station 20 via the network NW.

The data processing unit 102 extracts data from the frame input from the wired signal processing unit 101 and inputs the extracted data to the filtering unit 103. The data processing unit 102 generates a frame using the data input from the command library 108 and inputs the generated frame to the wired signal processing unit 101. The data processing unit 102 can use a remote login (secure shell (SSH) or the like).

The filtering unit 103 classifies the data input from the data processing unit 102 and inputs the classified data to the storage unit 104.

The storage unit 104 stores information regarding communication of an apparatus belonging to the wireless communication system 1. Specifically, the storage unit 104 can store transmission constraint information 110, apparatus management information 111, and communication quality information 112. The transmission constraint information 110 includes a constraint condition related to transmission (wireless communication) between apparatuses belonging to the wireless communication system 1. The constraint condition is set based on a law, for example. The apparatus management information 111 includes information regarding an apparatus belonging to the data processing apparatus 10 and a transmission control parameter of at least one apparatus belonging to the wireless communication system 1. The transmission control parameters may include a plurality of types of control parameters applied to wireless communication using the wireless communication module. Examples of the control parameters included in the transmission control parameters include a moderation and coding scheme (MCS), a used channel, a frame length, a transmission frequency, and a transmission rate. The communication quality information 112 is data input from the filtering unit 103 and includes information regarding quality of a link established between apparatuses belonging to the wireless communication system 1. The communication quality information 112 may include information regarding communication quality of at least one apparatus belonging to the wireless communication system 1.

The operation software execution unit 105 updates each of the transmission constraint information 110 and the apparatus management information 111 stored in the storage unit 104 in response to an operation of the input interface 16. Each of the transmission constraint information 110 and the apparatus management information 111 is preferably input before a communication management operation to be described below is executed. The operation software execution unit 105 can instruct the control unit 106 to execute a communication management operation.

The control unit 106 can control the storage unit 104, the operation software execution unit 105, the calculation unit 107, and the command library 108. The control unit 106 executes a communication management operation to be described below.

The calculation unit 107 executes a calculation process using each piece of information stored in the storage unit 104 under the control of the control unit 106. This calculation process relates to determination of a parameter for improving quality of a link between apparatuses belonging to the wireless communication system 1. Details of the arithmetic processing will be described below.

The command library 108 stores a command related to control of an apparatus belonging to the wireless communication system 1. For example, the command library 108 includes a command used to give an instruction for executing an information collection operation to be described below and a command used to give an instruction for executing a setting change operation to be described below. Then, the command library 108 inputs data including a command selected in response to control of the control unit 106, a transmission control parameter applied to a transmission target apparatus, and the like to the data processing unit 102.

In the data processing apparatus 10, a process of each of the wired signal processing unit 101 and the data processing unit 102 is implemented by the wired communication module 17 or the like. The process of the filtering unit 103 is implemented by the CPU 11, the RAM 13, and the like. The process of the storage unit 104 is implemented by the RAM 13, the storage 15, and the like. A process of each of the operation software execution unit 105, the control unit 106, the calculation unit 107, and the command library 108 is implemented by the CPU 11, the ROM 12, the RAM 13, and the like. The present invention is not limited thereto, and the functional configuration of the data processing apparatus 10 may be other classifications.

(Functional Configuration of Base Station 20)

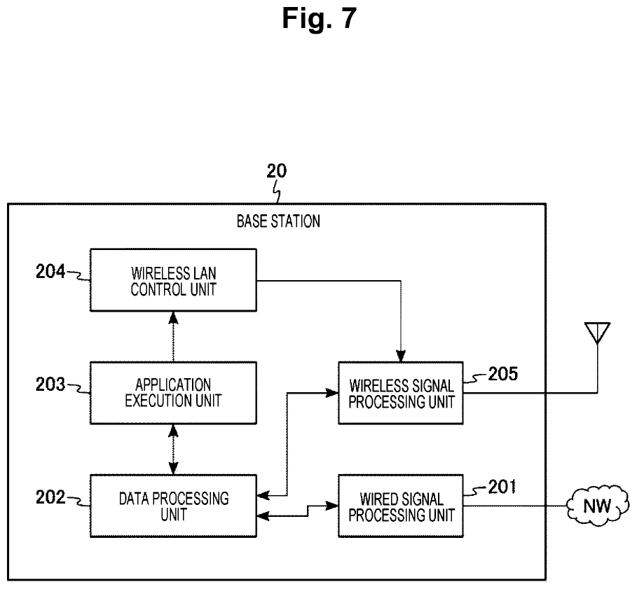

FIG. 7 is a block diagram illustrating an example of a functional configuration of the base station 20 included in the wireless communication system 1 according to the first embodiment. As illustrated in FIG. 7, the base station 20 includes, for example, a wired signal processing unit 201, a data processing unit 202, an application execution unit 203, a wireless LAN control unit 204, and a wireless signal processing unit 205.

The wired signal processing unit 201 handles data communication via the network NW based on TCP/IP. The wired signal processing unit 201 inputs the frame received from the data processing apparatus 10 via the network NW to the data processing unit 202. The wired signal processing unit 201 transmits a frame input from the data processing unit 202 to the data processing apparatus 10 via the network NW.

The data processing unit 202 extracts data from the frame input from the wired signal processing unit 201 or the wireless frame input from the wireless signal processing unit 205 and inputs the extracted data to the application execution unit 203. In addition, the data processing unit 202 generates a frame or a wireless frame according to a destination of the data by using the data input from the application execution unit 203. Then, the data processing unit 202 inputs the generated frame to the wired signal processing unit 201 and inputs the generated wireless frame to the wireless signal processing unit 205. The data processing unit 202 can use SSH.

The application execution unit 203 executes an application that can use the data input from the data processing unit 202. Then, the application execution unit 203 inputs data to the data processing unit 202 and acquires data from the data processing unit 202 in response to an operation of the application. The application execution unit 203 can change control of the wireless LAN control unit 204 and a transmission control parameter of the wireless LAN control unit 204 in response to a command and a transmission control parameter transferred from the data processing apparatus 10.

The wireless LAN control unit 204 can control the wireless signal processing unit 205, and manages a setting of wireless communication by the wireless signal processing unit 205. The wireless LAN control unit 204 can execute a quality measurement operation to be described below based on an instruction from the application execution unit 203. The wireless LAN control unit 204 can change the transmission control parameter related to the wireless communication of the base station 20 according to an instruction from the application execution unit 203.

The wireless signal processing unit 205 handles data communication using a wireless signal based on TCP/IP. The wireless signal processing unit 205 converts a wireless signal received via the antenna of the base station 20 into a wireless frame and inputs the converted wireless frame to the data processing unit 202. The wireless signal processing unit 205 converts the wireless frame input from the data processing unit 202 into a wireless signal and delivers the converted wireless signal via the antenna of the base station 20.

In the base station 20, a process of the wired signal processing unit 201 is implemented by the wired communication module 25 or the like. A process of the data processing unit 202 is implemented by the wireless communication module 24, the wired communication module 25, or the like. A process of each of the application execution unit 203 and the wireless LAN control unit 204 is implemented by the CPU 21, the RAM 23, and the like. The process of the wireless signal processing unit 205 is implemented by the wireless communication module 24 and the like. The present invention is not limited thereto, and the functional configuration of the base station 20 may be other classifications.

(Functional Configuration of Terminal Apparatus 30)

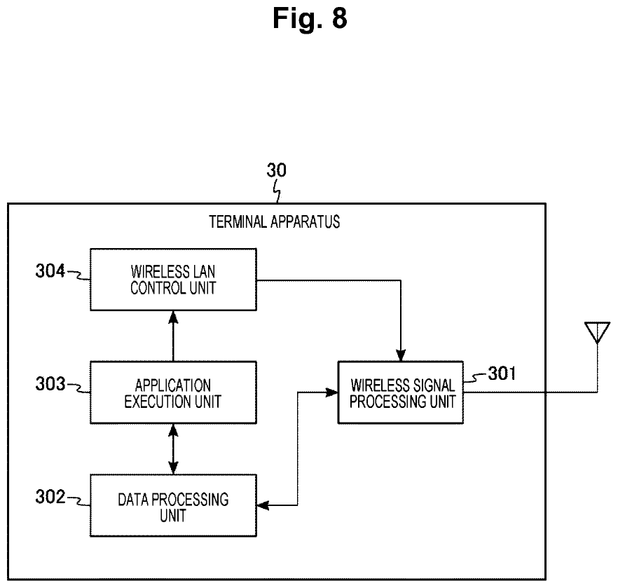

FIG. 8 is a block diagram illustrating an example of a functional configuration of the terminal apparatus 30 included in the wireless communication system 1 according to the first embodiment. As illustrated in FIG. 8, the terminal apparatus 30 includes, for example, a wireless signal processing unit 301, a data processing unit 302, an application execution unit 303, and a wireless LAN control unit 304.

The wireless signal processing unit 301 handles data communication using wireless signals based on TCP/IP. The wireless signal processing unit 301 converts a wireless signal received via an antenna of the terminal apparatus 30 into a wireless frame and inputs the converted wireless frame to the data processing unit 302. The wireless signal processing unit 301 converts the wireless frame input from the data processing unit 302 into a wireless signal and delivers the converted wireless signal via the antenna of the terminal apparatus 30.

The data processing unit 302 extracts data from the wireless frame input from the wireless signal processing unit 301 and inputs the extracted data to the application execution unit 303. The data processing unit 302 generates a wireless frame using the data input from the application execution unit 303 and inputs the generated wireless frame to the wireless signal processing unit 301. The data processing unit 302 can use SSH.

The application execution unit 303 executes an application that can use the data input from the data processing unit 302. Then, the application execution unit 303 inputs data to the data processing unit 302 and acquires data from the data processing unit 302 in response to an operation of the application. The application execution unit 303 can change control of the wireless LAN control unit 304 and a transmission control parameter of the wireless LAN control unit 304 in response to a command and a transmission control parameter transferred from the data processing apparatus 10.

The wireless LAN control unit 304 can control the wireless signal processing unit 301 and manages a setting of wireless communication by the wireless signal processing unit 301. The wireless LAN control unit 304 can execute a quality measurement operation to be described below in response to an instruction from the application execution unit 303. The wireless LAN control unit 304 can change a transmission control parameter related to the wireless communication of the terminal apparatus 30 in response to an instruction from the application execution unit 303.

In the terminal apparatus 30, a process of each of the wireless signal processing unit 301 and the data processing unit 302 is implemented by the wireless communication module 36 or the like. A process of each of the application execution unit 303 and the wireless LAN control unit 304 is implemented by the CPU 31, the RAM 33, and the like. The present invention is not limited thereto, and the functional configuration of the base station 20 may be other classifications.

<1-2> (Operation)

Hereinafter, an operation of the wireless communication system 1 according to the first embodiment will be described below.

In the wireless communication system 1 according to the first embodiment, a constraint condition is set for communication between the base station 20 and the terminal apparatus 30 belonging to the wireless communication system 1. Then, the wireless communication system 1 executes a communication management operation of optimizing a transmission control parameter in a basic service set (BSS) based on the constraint condition and the communication quality information acquired from the terminal apparatus 30.

<1-2-1> Overview of Communication Management Operation

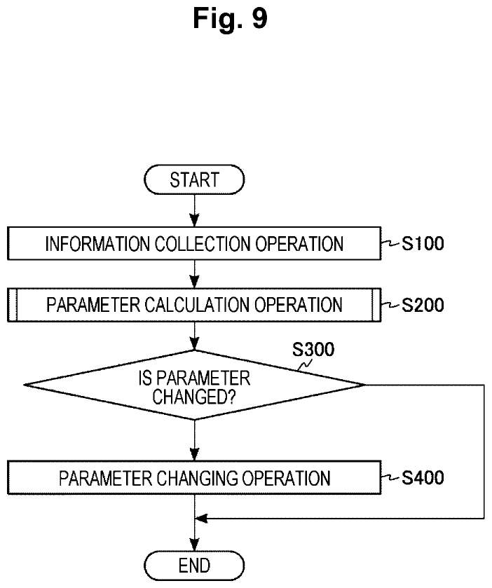

FIG. 9 is a flowchart illustrating an example of a communication management operation in the wireless communication system 1 according to the first embodiment. An overview of a communication management operation in the wireless communication system 1 according to the first embodiment will be described below with reference to FIG. 9.

The data processing apparatus 10 starts a communication management operation based on a user operation (input from the outside) or a preset schedule (START). For example, a trigger for starting the communication management operation in response to an input from the outside is generated by the operation software execution unit 105. The trigger for starting the communication management operation in accordance with to the preset schedule is generated based on a time of the timer 14 referred to by the control unit 106.

When the communication management operation is started, the data processing apparatus 10 executes an information collection operation (step S100). The information collection operation is an operation in which the data processing apparatus 10 acquires information regarding communication quality from at least one terminal apparatus 30 belonging to the wireless communication system 1. In the information collection operation, the terminal apparatus 30 measures information (data) related to communication quality and transfers the data to the data processing apparatus 10 via the base station 20. Hereinafter, the information regarding the communication quality acquired by the information collection operation is referred to as “communication quality information QI”.

When the information collection operation is ended, the data processing apparatus 10 executes a parameter calculation operation (step S200). The parameter calculation operation is an operation of calculating a transmission control parameter preferable in the wireless communication between the base station 20 and the terminal apparatus 30 using the communication quality information QI acquired by the information collection operation, a preset constraint condition, and the like. Details of the parameter calculation operation will be described below.

When the parameter calculation operation is ended, the data processing apparatus 10 checks whether there is a difference between the transmission control parameter before execution of the communication management operation and the transmission control parameter determined through the parameter calculation operation (step S300). That is, the data processing apparatus 10 checks whether the transmission control parameter of the terminal apparatus 30 in the wireless communication system 1 is changed.

When the parameter is changed (YES in step S300), the data processing apparatus 10 executes the parameter changing operation (step S400). The parameter changing operation is an operation of applying the transmission control parameter determined by the parameter calculation operation to the transmission control parameter of each terminal apparatus 30 in the wireless communication system 1. When the parameter changing operation is completed, the data processing apparatus 10 ends the communication management operation (END).

When the parameter is not changed (NO in step S300), the data processing apparatus 10 ends the communication management operation without changing the transmission control parameter (END).

The information collection operation and the parameter calculation operation may be executed based on different schedules. For example, the data processing apparatus 10 may periodically execute the information collection operation and execute the parameter calculation operation based on a user operation or the like. In the first embodiment, it is sufficient that the data processing apparatus 10 may execute the parameter calculation operation using the communication quality information QI of at least one terminal apparatus 30 and executes the parameter changing operation as necessary.

<1-2-2> Specific Example of Communication Management Operation

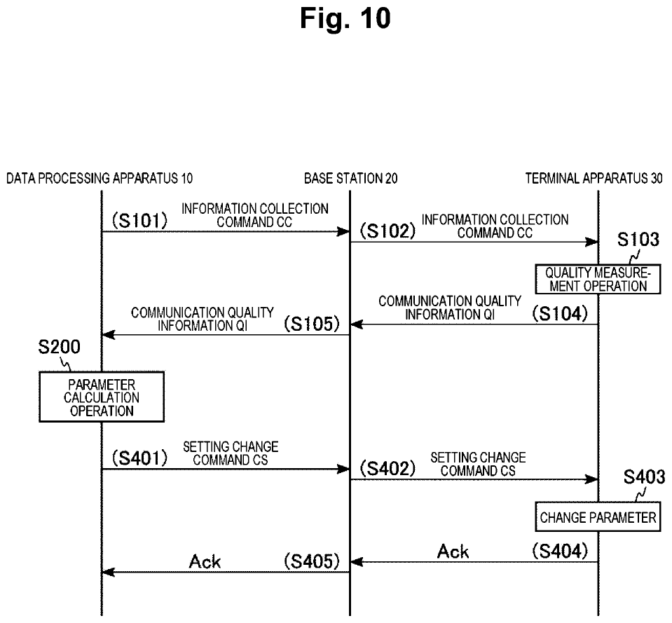

FIG. 10 is a time chart illustrating an example of a communication management operation in the wireless communication system 1 according to the first embodiment. Hereinafter, a specific example of the communication management operation in the wireless communication system 1 according to the first embodiment will be described with reference to FIG. 10.

When the communication management operation is started, the data processing apparatus 10 transmits an information collection command CC destined for the terminal apparatus 30 to the base station 20 (step S101). Specifically, the control unit 106 of the data processing apparatus 10 selects a command (information collection command CC) for collecting information regarding communication quality necessary for a parameter calculation operation to be described below from the command library 108 based on the information (apparatus management information 111) of the base station 20 and the terminal apparatus 30 stored in the storage unit 104. Then, the data processing unit 102 and the wired signal processing unit 101 transmit the information collection command CC destined for each terminal apparatus 30 belonging to the wireless communication system 1 to the base station 20.

The base station 20 transfers the information collection command CC destined for the terminal apparatus 30 received from the data processing apparatus 10 to the terminal apparatus 30 (step S102). When the plurality of terminal apparatuses 30 are connected to the base station 20, the information collection command CC is transmitted to each of the plurality of terminal apparatuses 30 wirelessly connected to the base station 20.

The terminal apparatus 30 executes the quality measurement operation based on the information collection command CC destined for the terminal apparatus 30 received from the base station 20 (step S103). The quality measurement operation is appropriately executed in accordance with the type of communication quality information requested in response to the information collection command CC. When the data related to the communication quality information requested from the data processing apparatus 10 has been measured, the quality measurement operation may be omitted.

When the quality measurement operation is ended, the terminal apparatus 30 transmits the communication quality information QI requested by the information collection command CC to the base station 20 (step S104).

The base station 20 transfers the communication quality information QI received from the terminal apparatus 30 to the data processing apparatus 10 (step S105). When the data processing apparatus 10 receives the communication quality information QI from the base station 20, the filtering unit 103 classifies the communication quality information QI and stores the classified communication quality information QI in the storage unit 104. In other words, the data processing apparatus 10 updates the communication quality information 112 in the storage unit 104 based on the communication quality information QI received from the base station 20.

The above-described process of steps S101 to S105 corresponds to the information collection operation (step S100) illustrated in FIG. 9.

When the communication quality information QI of the terminal apparatus 30 is received from the base station 20, the data processing apparatus 10 executes the parameter calculation operation (step S200). In this example, the transmission control parameter of each terminal apparatus 30 determined through the parameter calculation operation is different from the transmission control parameter of each terminal apparatus 30 before the start of the communication management operation.

In this case, when the parameter calculation operation is ended, the data processing apparatus 10 transmits a setting change command CS destined for the terminal apparatus 30 to the base station 20 (step S401). Specifically, the control unit 106 of the data processing apparatus 10 selects a command (the setting change command CS) necessary for setting a control parameter that needs to be changed from the command library 108 based on the information (the apparatus management information 111) of the base station 20 and the terminal apparatus 30 stored in the storage unit 104. Then, the data processing unit 102 and the wired signal processing unit 101 transmit the setting change command CS destined for each terminal apparatus 30 belonging to the wireless communication system 1 to the base station 20. A numerical value of a specific transmission control parameter optimized for each terminal apparatus 30 or the like may be added to the setting change command CS.

The base station 20 transfers the setting change command CS destined for the terminal apparatus 30 received from the data processing apparatus 10 to the terminal apparatus 30 (step S402). When the plurality of terminal apparatuses 30 are connected to the base station 20, the setting change command CS is transmitted to each of the plurality of terminal apparatuses 30 wirelessly connected to the base station 20. The content of the setting change command CS may be different for each transmission destination terminal apparatus 30.

The terminal apparatus 30 changes the transmission control parameter of the terminal apparatus 30 in the wireless communication system 1 in response to the setting change command CS destined for the terminal apparatus 30 received from the base station 20 (step S403: Change in parameter). Specifically, when the terminal apparatus 30 receives the setting change command CS, the application execution unit 303 sets the transmission control parameter based on the setting change command CS in the wireless LAN control unit 304. Accordingly, the setting of the wireless communication between the base station 20 and the terminal apparatus 30 is changed.

Then, the terminal apparatus 30 transmits an acknowledgement (Ack) for notifying that the changing of the parameter has been executed to the base station 20 (step S404).

The base station 20 transfers an acknowledgement received from the terminal apparatus 30 to the data processing apparatus 10 (step S405).

The above-described process of steps S401 to S405 corresponds to the parameter changing operation (step S400) illustrated in FIG. 9. In the parameter changing operation, the acknowledgement in steps S404 and S405 may be omitted.

The data processing apparatus 10 may transmit the information collection command CC to the base station 20. For example, when the information collection command CC destined for the base station 20 is received, the base station 20 appropriately executes the quality measurement operation similarly to the terminal apparatus 30. Then, the base station 20 transmits the communication quality information QI requested in response to the information collection command CC to the data processing apparatus 10.

The data processing apparatus 10 may transmit the setting change command CS to the base station 20. When receiving the setting change command CS destined for the base station 20, the base station 20 changes the transmission control parameter similarly to the terminal apparatus 30. Specifically, when the base station 20 receives the setting change command CS, the application execution unit 203 sets the transmission control parameter based on the setting change command CS in the wireless LAN control unit 204. Accordingly, the setting of the wireless communication between the base station 20 and the data processing apparatus 10 is changed.

<1-2-3> Details of Parameter Calculation Operation

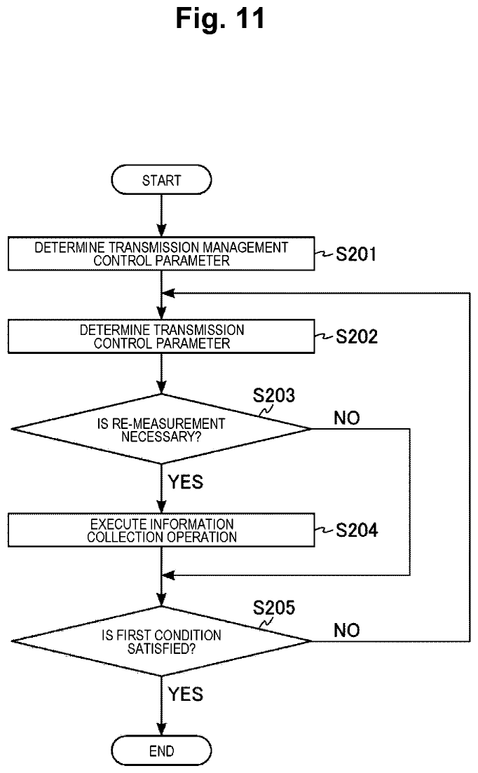

FIG. 11 is a flowchart illustrating an example of a parameter calculation operation in the data processing apparatus included in the wireless communication system 1 according to the first embodiment. Hereinafter, details of the parameter calculation operation (that is, the operation in step S200 illustrated in FIG. 9) in the wireless communication system 1 according to the first embodiment will be described with reference to FIG. 11.

For example, when the information collection operation (step S100) illustrated in FIG. 9 ends, the data processing apparatus 10 starts the parameter calculation operation (START).

When the parameter calculation operation is started, the control unit 106 of the data processing apparatus 10 determines the transmission management control parameter (step S201). The transmission management control parameter indicates a constraint condition when various transmission control parameters are optimized, and can be set for each type of control parameter of wireless communication. The transmission management control parameter is determined based on, for example, the transmission constraint information 110, the apparatus management information 111, and the communication quality information 112. The transmission management control parameter indicates, for example, a limit of a transmittable time set in consideration of a transmission time ratio defined by law. Further, the limitation of the transmission time in the transmission management control parameter may be determined based on restriction of a driving time of the terminal apparatus 30 when the terminal apparatus 30 is driven by a battery.

When the transmission management control parameter is determined, the calculation unit 107 of the data processing apparatus 10 determines the transmission control parameter (step S202). Specifically, the calculation unit 107 of the data processing apparatus 10 calculates the optimum value of the transmission control parameter for each terminal apparatus 30 based on the apparatus management information 111 and the communication quality information 112 stored in the storage unit 104 and the transmission management control parameter determined in step S201.

When the transmission control parameter is determined, the control unit 106 of the data processing apparatus 10 checks whether it is necessary to re-measure the communication quality (step S203). For example, when there is a terminal apparatus 30 of which an MCS or a channel has been changed, the control unit 106 determines that it is necessary to re-measure the communication quality. For example, when the transmission control parameter is changed only by a frame length, the control unit 106 determines that it is not necessary to re-measure the communication quality.

When the re-measurement is necessary (YES in step S203), the control unit 106 of the data processing apparatus 10 executes an information collection operation for the terminal apparatus 30 for which the re-measurement is necessary (step S204). When the information collection operation for the terminal apparatus 30 for which the remeasurement is necessary is ended, the control unit 106 of the data processing apparatus 10 causes the process to proceed to step S205.

When the re-measurement is not necessary (NO in step S203), the control unit 106 of the data processing apparatus 10 causes the process to proceed to step S205.

In the process of step S205, the control unit 106 of the data processing apparatus 10 checks whether the first condition is satisfied (step S205). A first condition is, for example, a condition regarding whether the number of times the process of step S202 is executed exceeds a predetermined number of times in the communication management operation. In this case, a conditional branch in step S205 is “NO” when the number of times the process of in step S202 is executed equal to or less than a predetermined number of times and is “YES” when the number of times the process of in step S202 is executed exceeds the predetermined number of times. The first condition may be a condition regarding whether the transmission control parameter determined before and after step S202 have changed. In this case, a conditional branch in step S205 is “NO” when the transmission control parameter before execution of step S202 is different from the transmission control parameter determined in step S202 and is “YES” when the transmission control parameters are the same. The first condition may be set depending on a state of the communication quality information QI acquired through the information collection operation of step S204. In this case, a conditional branch in step S205 is “NO” when the communication quality information QI acquired in the information collection operation after a change in the channel is different from the assumed communication quality information QI (for example, when an influence of external interference or the like is detected) and is “YES” when the communication quality information QI is the assumed communication quality information QI.

When the first condition is not satisfied (NO in step S205), the control unit 106 of the data processing apparatus 10 cause the process to proceed to step S202.

When the first condition is satisfied (YES in step S205), the control unit 106 of the data processing apparatus 10 ends the parameter calculation operation (END). Then, the data processing apparatus 10 causes the process to proceed to step S300 illustrated in FIG. 9. That is, the data processing apparatus 10 reflects the transmission control parameter obtained through the parameter calculation operation in each terminal apparatus 30 as necessary.

As described above, in the wireless communication system 1 according to the first embodiment, the data processing apparatus 10 includes the storage unit 104 configured to be able to store information (the transmission constraint information 110) regarding the constraint condition related to the wireless communication of the terminal apparatus 30. In the parameter calculation operation, the control unit 106 of the data processing apparatus 10 executes the first operation (steps S202 to S205) under the constraint condition related to the wireless communication of the terminal apparatus 30. In the first operation, the control unit 106 controls the calculation unit 107 such that the transmission control parameter used for the wireless communication of the terminal apparatus 30 is determined and the transmission control parameter is repeatedly determined again using the determined transmission control parameter when the determined transmission control parameter is different from the transmission control parameter before the determination. The control unit 106 is configured to be able to execute an operation of applying the transmission control parameter obtained through the parameter calculation operation to the terminal apparatus 30. The control unit 106 uses the communication information of the terminal apparatus 30 collected from the terminal apparatus 30 when the transmission control parameter is determined again. Further, in the first operation, the control unit 106 collects the communication information of the terminal apparatus 30 from the terminal apparatus 30 based on a change in the first control parameter (for example, a channel) among the transmission control parameters and uses the collected communication information of the terminal apparatus 30 to determine a subsequent transmission control parameter.

<1-3> Advantageous Effects of First Embodiment

The wireless communication system 1 according to the above-described first embodiment can be caused to implement stable wireless communication. Hereinafter, advantageous effects of the wireless communication system 1 according to the embodiment will be described in detail.

In order to make the IoT wireless network available in a wide range, a 920 MHz band, or the like in which a communication distance is long is used for wireless communication. When the 920 MHz band or the like which is an unlicensed band is used, it is necessary to comply with the transmission time limit or the like according to the National Radio Law. The unlicensed band is used not only in the own standard but also in other standards. Therefore, the transmission control parameter for each terminal apparatus is preferably set in consideration of various types of interference and the like. As a countermeasure, it is conceivable that a data processing apparatus that generally controls a wireless network is provided, and the data processing apparatus executes an operation (parameter calculation operation) of optimizing the transmission control parameter for each terminal apparatus in consideration of various types of interference and the like.

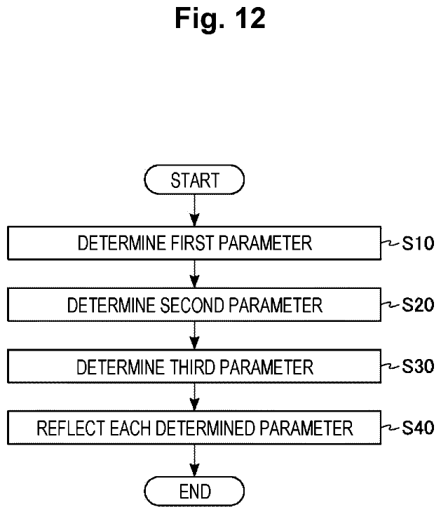

FIG. 12 is a flowchart illustrating a parameter calculation operation according to a comparative example. As illustrated in FIG. 12, in the parameter calculation operation in the comparative example, the processes of steps S10, S20, S30, and S40 are sequentially executed. First, second, and third parameters related to transmission are determined respectively in steps S10, S20, and S30. In step S40, each control parameter determined in steps S10, S20, and S30 is reflected in the transmission control parameter of the terminal apparatus. As described above, when a sequence is provided in the optimization of the control parameters, there is a possibility that another control parameter is likely to deviate from the optimum value despite optimization of a certain control parameter. In other words, there is a possibility that the control parameter for which optimization has been previously executed is not an optimum value as the control parameter for which optimization has been subsequently executed is changed. As described above, the transmission control parameter includes a plurality of types of control parameters related to each other.

Accordingly, in the wireless communication system 1 according to the first embodiment, the data processing apparatus collects the communication quality information QI from each terminal apparatus 30 via the base station 20. Then, the data processing apparatus 10 changes the constraint condition (transmission constraint information 110) to a numerical value used for the control parameter optimization calculation and repeatedly executes the optimization of the related control parameter using the numerical value as a constraint. In other words, the data processing apparatus 10 optimizes the control parameter to be controlled within the area of the wireless LAN by repeatedly executing an optimization process for a plurality of control parameters related to each other in consideration of the constraint condition. In order not to fall into an endless loop, the parameter calculation operation includes an end condition (first condition) such as limitation of the number of calculations of the control parameter and ending of the calculation when the same calculation result is obtained. Then, the data processing apparatus 10 sets, for each of the base station 20 and the terminal apparatus 30, the setting of the transmission control parameter considered to be optimum in a wireless LAN area formed setting the base station 20 as a start point.

Accordingly, even when the constraint condition related to the transmission control parameter is imposed, the plurality of related control parameters related to the constraint condition can be more preferably set in terms of the entire network including the individual terminal apparatus 30 in the wireless communication system 1 according to the first embodiment. As a result, the wireless communication system 1 according to the first embodiment can implement stable wireless communication in the entire network.

The wireless communication system 1 according to the first embodiment can improve the communication stability of uplink traffic of the terminal apparatus 30 by optimizing the transmission control parameter based on the communication quality information QI acquired from the terminal apparatus 30. For example, an improvement in throughput can be expected by minimizing collision between the terminal apparatuses 30 belonging to the wireless communication system 1 or selecting an optimum modulation or demodulation scheme based on interference power received by the base station 20.

<1-4> Modification of First Embodiment

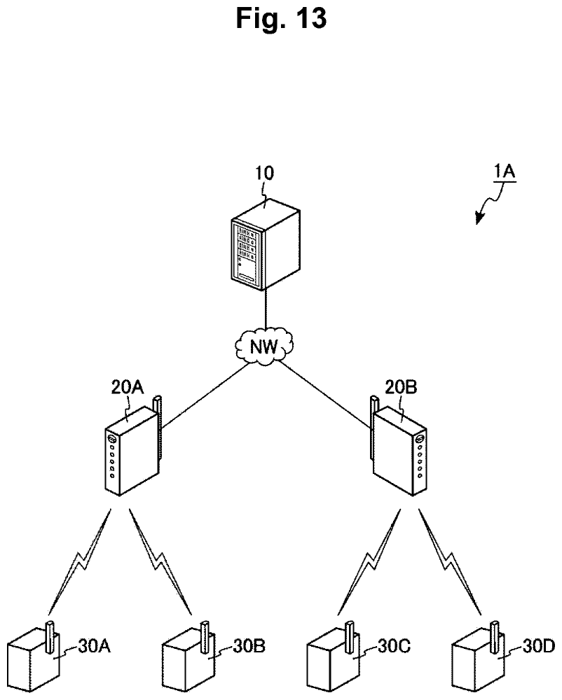

FIG. 13 is a conceptual diagram illustrating an example of an overall configuration of a wireless communication system LA according to a modification of the first embodiment. As illustrated in FIG. 13, a wireless communication system 1A according to the modification of the first embodiment includes a data processing apparatus 10, base stations 20A and 20B, and terminal apparatuses 30A, 30B, 30C, and 30D.

Each of the base stations 20A and 20B is configured to be able to communicate with the data processing apparatus 10 via the network NW. Each of the terminal apparatuses 30A and 30B is wirelessly connected to the base station 20A. Each of the terminal apparatuses 30C and 30D is wirelessly connected to the base station 20B. As described above, a plurality of base stations 20 may belong to the wireless communication system 1. The data processing apparatus 10 can execute the communication management operation described in the first embodiment on each of the plurality of base stations 20. The data processing apparatus can execute an information collection operation and a setting change operation on the terminal apparatus 30 belonging to the wireless communication system 1 via any one of the plurality of base stations 20.

In the wireless communication system 1A according to the modification of the first embodiment, the base station 20 which is a connection destination of the terminal apparatus 30 may be changed through the communication management operation. By optimizing the base station 20 which is a connection destination of the terminal apparatus 30 through the communication management operation, the number of connections to the terminal apparatus 30 can be inhibited from being biased to a specific base station 20, and a decrease in access efficiency of the base station 20 can be inhibited. Furthermore, the number of base stations 20 belonging to the wireless communication system 1A can be designed to any number within the range of performance of the data processing apparatus 10. In the wireless communication system 1A, any base station 20 may have the function of the data processing apparatus among the plurality of base stations 20. When any base station has the function of the data processing apparatus 10 among the plurality of base stations 20, the data processing apparatus 10 may be omitted from the wireless communication system 1A.

### <2> Second Embodiment

A wireless communication system 1B according to a second embodiment has a configuration in which a satellite base station is added to the wireless communication system 1 according to the first embodiment and constructs a mesh network. Then, the wireless communication system 1B according to the second embodiment executes a communication management operation in consideration of presence of the satellite base station 40. Hereinafter, differences between the wireless communication system 1 according to the second embodiment and the wireless communication system according to the first embodiment will be described.

<2-1> Configuration

<2-1-1> Overall Configuration of Wireless Communication System 1B

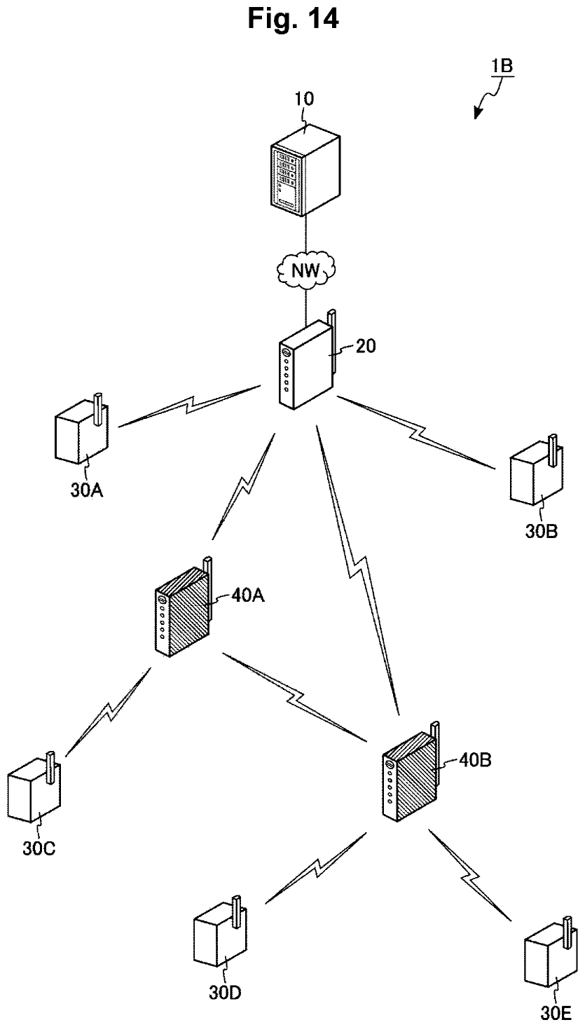

FIG. 14 is a conceptual diagram illustrating an example of an overall configuration of the wireless communication system 1B according to the second embodiment. As illustrated in FIG. 14, the wireless communication system 1B according to the second embodiment includes a data processing apparatus 10, a base station 20, a terminal apparatus 30, and a satellite base station 40.

The satellite base station 40 is a wireless LAN access point configured to be connectable to the base station 20. The satellite base station 40 is configured to be wirelessly connectable to another satellite base station 40 or one or more terminal apparatuses TA using one type of band or a plurality of types of bands. The satellite base station 40 may be wirelessly connected to both the satellite base station 40 and the terminal apparatus TA or may be wirelessly connected to one of the satellite base station 40 and the terminal apparatus TA.

In this example, in the wireless communication system 1B, a mesh network is constructed by the base station 20 and the two satellite base stations 40A and 40B. Specifically, the satellite base stations 40A and 40B are wirelessly connected to the base station 20, and the satellite base station 40B is wirelessly connected to the satellite base station 40A. Then, five terminal apparatuses 30A, 30B, 30C, 30D, and 30E are wirelessly connected to the constructed mesh network. The terminal apparatuses 30A and 30B are wirelessly connected to the base station 20. The terminal apparatus 30C is wirelessly connected to the satellite base station 40A. Each of the terminal apparatuses 30D and 30E is wirelessly connected to the satellite base station 40B.

The data processing apparatus 10 in the second embodiment can change a connection destination of each terminal apparatus 30 to another base station 20 or another satellite base station 40 in accordance with communication quality of each terminal apparatus 30. The data processing apparatus 10 according to the second embodiment can change the transmission control parameter of each satellite base station 40 in accordance with the communication quality of each satellite base station 40, and can change the transmission control parameter of each terminal apparatus 30 in accordance with communication quality of each terminal apparatus 30. Further, the data processing apparatus 10 according to the second embodiment can change a communication path of each terminal apparatus 30 in accordance with the communication quality of each terminal apparatus 30.

The wireless communication system 1B according to the second embodiment may have other configurations. For example, the number of terminal apparatuses 30 belonging to the wireless communication system 1B can be designed to any number within the range of performance of each of the data processing apparatus 10, the base station 20, and the satellite base station 40. The number of satellite base stations 40 may be designed to any number within a performance range of each of the data processing apparatus 10 and the base station 20. The base station 20 may have a function of the data processing apparatus 10. When the base station 20 has the function of the data processing apparatus 10, the data processing apparatus 10 can be omitted from the wireless communication system 1.

<2-1-2> Hardware Configuration of Satellite Base Station 40

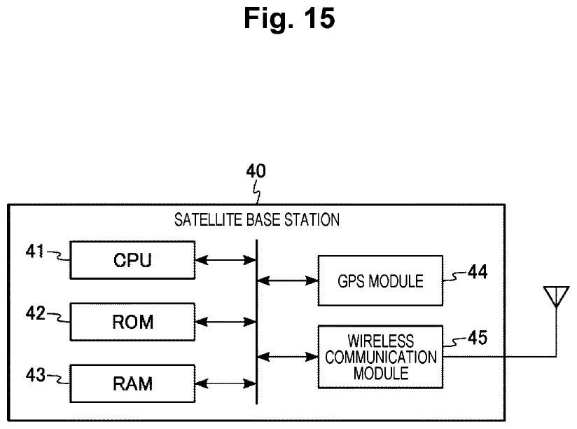

FIG. 15 is a block diagram illustrating an example of a hardware configuration of the satellite base station 40 included in the wireless communication system 1B according to the second embodiment. As illustrated in FIG. 15, the satellite base station includes, for example, a CPU 41, a ROM 42, a RAM 43, a GPS module 44, and a wireless communication module 45.

The CPU 41 is an integrated circuit capable of executing various programs. The CPU 41 controls an overall operation of the satellite base station 40.

The ROM 42 is a nonvolatile semiconductor memory. The ROM 42 stores programs, control data, and the like for controlling the satellite base station 40.

The RAM 43 is, for example, a volatile semiconductor memory. The RAM 43 is used as a working area of the CPU 41.

The GPS module 44 is a circuit capable of receiving radio waves from GPS satellites and acquiring position data of the satellite base station 40.

The wireless communication module 45 is a circuit used to transmit and receive data by a wireless signal. The wireless communication module 45 is configured to be connectable to an antenna and may include a plurality of communication modules respectively corresponding to a plurality of frequency bands.

The other hardware configurations of the wireless communication system 1B according to the second embodiment are similar to those of the wireless communication system 1 according to the first embodiment. The satellite base station 40 may have another hardware configuration. For example, when the wireless communication system 1 does not use the positional information of the satellite base station 40, the GPS module 44 may be omitted from the satellite base station 40.

<2-1-3> Functional Configuration of Satellite Base Station 40

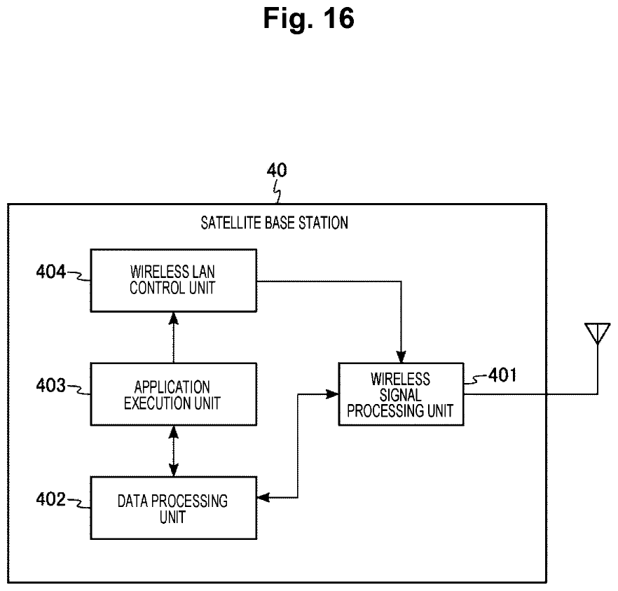

FIG. 16 is a block diagram illustrating an example of a functional configuration of the satellite base station 40 included in the wireless communication system 1B according to the second embodiment. As illustrated in FIG. 16, the satellite base station 40 includes, for example, a wireless signal processing unit 401, a data processing unit 402, an application execution unit 403, and a wireless LAN control unit 404. A process of the wireless signal processing unit 401 is implemented by the wireless communication module 45 or the like. A process of each of the data processing unit 402, the application execution unit 403, and the wireless LAN control unit 404 is implemented by the CPU 41, the ROM 42, the RAM 43, and the like.

The wireless signal processing unit 401 handles data communication using wireless signals based on TCP/IP. The wireless signal processing unit 401 converts a wireless signal received via an antenna of the satellite base station 40 into a wireless frame and inputs the converted wireless frame to the data processing unit 402. The wireless signal processing unit 401 converts the wireless frame input from the data processing unit 402 into a wireless signal and delivers the converted wireless signal via the antenna of the satellite base station 40.

The data processing unit 402 extracts data from the wireless frame input from the wireless signal processing unit 401 and inputs the extracted data to the application execution unit 403. The data processing unit 402 generates a wireless frame using the data input from the application execution unit 403 and inputs the generated wireless frame to the wireless signal processing unit 401.

The application execution unit 403 executes an application that can use the data input from the data processing unit 402. Then, the application execution unit 403 inputs data to the data processing unit 402 and acquires data from the data processing unit 402 in response to an operation of the application. The application execution unit 403 can change control of the wireless LAN control unit 404 and the transmission control parameter of the wireless LAN control unit 404 in response to a command and a transmission control parameter transferred from the data processing apparatus 10.

The wireless LAN control unit 404 can control the wireless signal processing unit 401 and manages a setting of wireless communication by the wireless signal processing unit 401. The wireless LAN control unit 404 can execute the quality measurement operation based on an instruction from the application execution unit 403. The wireless LAN control unit 404 can change a transmission control parameter related to wireless communication of the satellite base station 40 in response to an instruction from the application execution unit 403.

In the satellite base station 40, a process of each of the wireless signal processing unit 401 and the data processing unit 402 is implemented by the wireless communication module 45 or the like. Each processing of the application execution unit 403 and the wireless LAN control unit 404 is realized by the CPU 41, the RAM 43, and the like. The present invention is not limited thereto, and the functional configuration of the satellite base station 40 may be of another type. The other functional configurations of the wireless communication system 1B according to the second embodiment are similar to those of the wireless communication system 1 according to the first embodiment.

<2-2> Operation

An operation of the wireless communication system 1B according to the second embodiment will be described below.

The wireless communication system 1B according to the second embodiment executes a communication management operation similar to that of the first embodiment in a mesh network including the satellite base station 40.

<2-2-1> Specific Example of Communication Management Operation

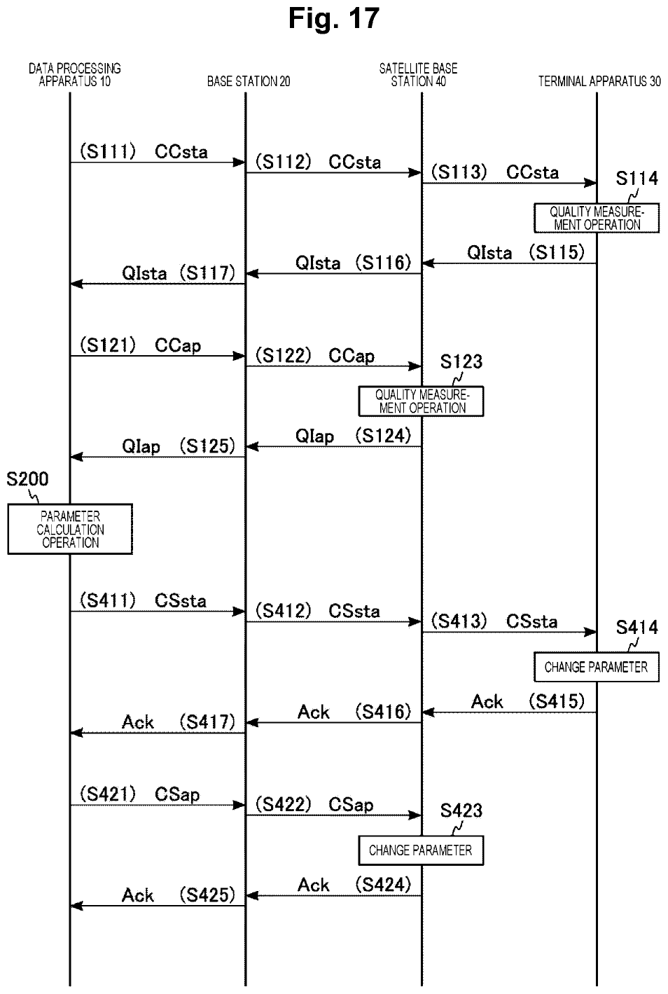

FIG. 17 is a time chart illustrating an example of a communication management operation in the wireless communication system according to the second embodiment. FIG. 17 illustrates an operation example when wireless communication between the base station 20 and the terminal apparatus 30 is executed via one satellite base station 40, and the information collection operation and the parameter changing operation are executed for each of the terminal apparatus 30 and the satellite base station 40. Hereinafter, a specific example of the communication management operation in the wireless communication system 1B according to the second embodiment will be described with reference to FIG. 17.

When the communication management operation is started, the data processing apparatus 10 transmits an information collection command CC destined for the terminal apparatus 30 to the base station 20 (step S111). Specifically, the control unit 106 of the data processing apparatus 10 selects a command (information collection command CC) for collecting information regarding the communication quality necessary for the parameter calculation operation from the command library 108 based on the information (apparatus management information 111) of the base station 20, the satellite base station 40, and the terminal apparatus 30 stored in the storage unit 104. Then, the data processing unit 102 and the wired signal processing unit 101 transmit the information collection command CC destined for the selected terminal apparatus and the information collection command CC destined for each terminal apparatus 30 belonging to the wireless communication system 1 to the base station 20.

The base station 20 transfers an information collection command CCsta destined for the terminal apparatus 30 received from the data processing apparatus 10 to the satellite base station 40 (step S112). When a plurality of satellite base stations 40 are connected to the base station 20, the information collection command CC is transmitted along the communication path of each terminal apparatus 30.

The satellite base station 40 transfers the information collection command CCsta destined for the terminal apparatus 30 received from the base station 20 to the terminal apparatus 30 (step S113). When the plurality of terminal apparatuses 30 are connected to the satellite base station 40, the information collection command CC is transmitted to each terminal apparatus 30 wirelessly connected to the satellite base station 40.

The terminal apparatus 30 executes the quality measurement operation based on the information collection command CC destined for the terminal apparatus 30 received from the base station 20 (step S114). When the data related to the communication quality information requested from the data processing apparatus 10 has been measured, the quality measurement operation in step S114 may be omitted.

When the quality measurement operation is ended, the terminal apparatus 30 transmits communication quality information Qlsta requested in response to the information collection command CC to the satellite base station 40 (step S115).

The satellite base station 40 transfers the communication quality information QIsta received from the terminal apparatus 30 to the base station 20 (step S116).

The base station 20 transfers the communication quality information Qlsta received from the satellite base station 40 to the data processing apparatus 10 (step S117). Then, like the first embodiment, the data processing apparatus 10 updates the communication quality information 112 in the storage unit 104 based on the communication quality information QI received from the base station 20.

The above-described process of steps S111 to S117 corresponds to the information collection operation for the terminal apparatus 30.

When the communication management operation is started, the data processing apparatus 10 transmits an information collection command CCap destined for the satellite base station 40 to the base station 20 (step S121).

The base station 20 transfers the information collection command CCap destined for the satellite base station 40 received from the data processing apparatus 10 to the satellite base station 40 (step S122).

When the information collection command CCap destined for the satellite base station 40 is received, the satellite base station 40 executes the quality measurement operation (step S123). In this quality measurement operation, the communication quality between the base station 20 and the satellite base station 40 is measured. When the data related to the communication quality information requested from the data processing apparatus 10 has been measured, the quality measurement operation in step S123 may be omitted.

Then, the satellite base station 40 transfers the communication quality information QIap requested in response to the information collection command CCap to the base station 20 (step S124).

The base station 20 transfers the communication quality information QIap received from the satellite base station 40 to the data processing apparatus 10 (step S125).

The above-described process of steps S121 to S125 corresponds to the information collection operation for the satellite base station 40. The information collection operation for the terminal apparatus 30 and the information collection operation for the satellite base station 40 may be executed in a reverse order or may be executed in parallel.

When the communication quality information Qlsta and the communication quality information QIap of the terminal apparatus 30 are received from the base station 20, the data processing apparatus 10 executes a parameter calculation operation (step S200). In this example, each of the transmission control parameter in the satellite base station 40 and the transmission control parameter in the terminal apparatus 30 determined through the parameter calculation operation is different from the transmission control parameter before the communication management operation starts.

In this case, when the parameter calculation operation is ended, the data processing apparatus 10 transmits a setting change command CSsta destined for the terminal apparatus 30 to the base station 20 (step S411).

The base station 20 transfers the received setting change command CSsta destined for the terminal apparatus 30 to the satellite base station 40 (step S412).

The satellite base station 40 transfers the received setting change command CSsta destined for the terminal apparatus 30 to the terminal apparatus 30 (step S413).

When the setting change command CS destined for the terminal apparatus 30 is received, the terminal apparatus 30 changes the transmission control parameter in accordance with the transmission control parameter associated with the received setting change command CSsta (step S414: Change parameter).

Then, the terminal apparatus 30 transmits an acknowledgement (Ack) notifying that the parameter change has been executed to the satellite base station 40 (step S415).

When the acknowledgement from the terminal apparatus 30 is received, the satellite base station 40 transfers the received acknowledgement to the base station 20 (step S416).

The base station 20 transfers an acknowledgement received from the satellite base station 40 to the data processing apparatus 10 (step S417).

The above-described process of steps S411 to S417 corresponds to the parameter changing operation for the terminal apparatus 30.

When the parameter calculation operation is ended, the data processing apparatus 10 transmits a setting change command CSap destined for the satellite base station 40 to the base station 20 (step S421).

The base station 20 transfers the received setting change command CSap destined for the satellite base station 40 to the satellite base station 40 (step S422).

The satellite base station 40 changes the transmission control parameter in accordance with the transmission control parameter associated with the received setting change command CSap destined for the satellite base station 40 (step S423: Change parameter).

Then, the satellite base station 40 transmits an acknowledgement (Ack) notifying that the parameter change has been executed to the base station 20 (step S424).

The base station 20 transfers an acknowledgement received from the satellite base station 40 to the data processing apparatus 10 (step S425).

The above-described process of steps S421 to S425 corresponds to the parameter changing operation (step S400) for the satellite base station 40. The acknowledgements in steps S424 and S425 may be omitted. The parameter changing operation for the terminal apparatus 30 and the parameter changing operation for the satellite base station 40 may be executed in a reverse order or may be executed in parallel.

<2-2-2> Details of Parameter Calculation Operation

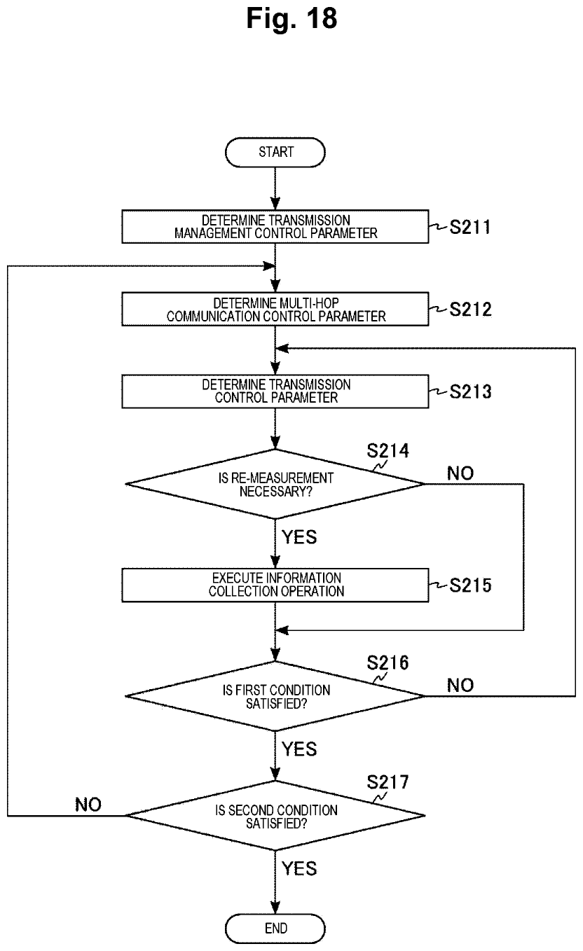

FIG. 18 is a flowchart illustrating an example of a parameter calculation operation in the data processing apparatus included in the wireless communication system 1B according to the second embodiment. Hereinafter, details of the parameter calculation operation (that is, the operation in step S200 illustrated in FIG. 9) in the wireless communication system 1 according to the second embodiment will be described with reference to FIG. 18.

For example, when the information collection operation (step S100) illustrated in FIG. 9 ends, the data processing apparatus 10 starts the parameter calculation operation (START).

When the parameter calculation operation is started, the control unit 106 of the data processing apparatus 10 determines the transmission management control parameter (step S211). Details of the transmission management control parameter are similar to those of the first embodiment.

When the transmission management control parameter is determined, the calculation unit 107 of the data processing apparatus 10 determines a multi-hop communication control parameter (step S212). Specifically, the calculation unit 107 of the data processing apparatus 10 calculates an optimum value of the multi-hop communication control parameter for each of the terminal apparatus 30 and the satellite base station 40 based on the apparatus management information 111, the communication quality information 112 stored in the storage unit 104, and the determined transmission management control parameter. In the determination of the multi-hop communication control parameter, for example, it is determined whether the terminal apparatus 30 scheduled to transmit data is directly connected to the base station 20 and whether the terminal apparatus 30 scheduled to transmit data is connected via the satellite base station 40. Further, when the multi-hop communication control parameter is determined, the limitation of the transmission time of each satellite base station 40 is taken into consideration. Then, a communication path between the data processing apparatus 10 and the terminal apparatus 30 is determined after the type of traffic to be passed, the number of terminal apparatuses 30 to be connected, and the like are also limited. In the limitation of the traffic and the number of apparatuses, for example, an upper limit of a transmission time in the subsequent satellite base station 40 or base station 20 is calculated using a present transmission control parameter (a modulation or demodulation scheme, a frame length, or the like).

When the multi-hop communication control parameter is determined, the calculation unit 107 of the data processing apparatus 10 determines the transmission control parameter (step S213). Specifically, the calculation unit 107 of the data processing apparatus 10 calculates the optimum value of the transmission control parameter for each of the terminal apparatus and the satellite base station 40 based on the apparatus management information 111 and the communication quality information 112 stored in the storage unit 104, the determined transmission management control parameter, and the multi-hop communication control parameter determined in step S212. In the determination of the transmission control parameter, for example, a moderation and coding scheme (MCS), a frame length, or the like is determined based on a received signal strength indicator (RSSI) value from the terminal apparatus 30 which is a destination of subsequent wireless communication or an RSSI value from the terminal apparatus 30 which is a destination of the present wireless communication in the determination of the multi-hop communication control parameter. Further, in the determination of the transmission control parameter, the calculation unit 107 may determine an optimum channel like the first embodiment.

When the transmission control parameter is determined, the control unit 106 of the data processing apparatus 10 checks whether it is necessary to re-measure the communication quality (step S214). For example, when there is the terminal apparatus 30 of which a modulation scheme or a channel has been changed, the control unit 106 determines that it is necessary to re-measure the communication quality. For example, when the transmission control parameter is changed only by a frame length, the control unit 106 determines that it is not necessary to re-measure the communication quality.

When the re-measurement is necessary (YES in step S214), the control unit 106 of the data processing apparatus 10 executes an information collection operation for at least one of the terminal apparatus 30 and the satellite base station 40 for which the re-measurement is necessary (step S215). When the information collection operation for at least one of the terminal apparatus 30 and the satellite base station 40 for which the re-measurement is necessary is ended, the control unit 106 of the data processing apparatus 10 causes the process to proceed to step S216.

When the re-measurement is not necessary (NO in step S214), the control unit 106 of the data processing apparatus 10 causes the process to proceed to step S216.

In the process of step S216, the control unit 106 of the data processing apparatus 10 checks whether the first condition is satisfied. The first condition is similar to that of the first embodiment.

When the first condition is not satisfied (NO in step S216), the control unit 106 of the data processing apparatus 10 causes the process to proceed to step S213. That is, the calculation unit 107 of the data processing apparatus 10 determines the transmission control parameter again.

When the first condition is satisfied (YES in step S216), the control unit 106 of the data processing apparatus 10 causes the process to proceed to step S217.

In the processing of step S216, the control unit 106 of the data processing apparatus 10 checks whether the second condition is satisfied. A second condition is, for example, a condition regarding whether the number of times the process of step S212 is executed exceeds a predetermined number of times in the communication management operation. In this case, a conditional branch in step S216 is “NO” when the number of times the process of step S212 is executed is equal to or less than the predetermined number of times and is “YES” when the number of times the process of step S212 is executed exceeds the predetermined number of times. The conditional branch of the second condition may be “NO” when the transmission control parameter is changed in step S213 processed most recently.

When the second condition is not satisfied (NO in step S217), the control unit 106 of the data processing apparatus 10 causes the process to proceed to step S212. That is, the calculation unit 107 of the data processing apparatus 10 determines the multi-hop communication control parameter again.

When the second condition is satisfied (YES in step S217), the control unit 106 of the data processing apparatus 10 ends the parameter calculation operation (END). Then, the data processing apparatus 10 causes the process to proceed to step S300 illustrated in FIG. 9, for example. That is, the data processing apparatus 10 reflects the transmission control parameter obtained through the parameter calculation operation in each of the satellite base stations 40 and each of the terminal apparatuses 30 as necessary.

As described above, in the wireless communication system 1B according to the second embodiment, the control unit 106 of the data processing apparatus 10 executes the second operation (steps S212 to S217) under the constraint conditions regarding the wireless communication of the terminal apparatus 30 in the parameter calculation operation. In the second operation, the control unit 106 controls the calculation unit 107 such that the multi-hop communication control parameter related to the communication path of the terminal apparatus 30 is determined and the first operation is executed (steps S213 to S216) after the multi-hop communication control parameter is determined. Further, in the second operation, when the transmission control parameter obtained through the first operation is related to the multi-hop communication control parameter after the first operation, the control unit 106 controls the calculation unit 107 such that the multi-hop communication control parameter is determined again using the transmission control parameter obtained through the first operation and the first operation is repeatedly executed again using the multi-hop communication control parameter determined again. Then, the control unit 106 is configured to be able to execute an operation of applying the multi-hop communication control parameter obtained through the parameter calculation operation to the terminal apparatus 30.

In the second embodiment, the process of step S212 and the process of step S216 are executed when the wireless communication system 1B executes the multi-hop communication. That is, when the wireless communication system 1 has a topology in which there are no relay stations, the process of step S212 and the process of step S216 are skipped.

<2-3> Advantageous Effects of Second Embodiment

When there is a constraint on a transmission time for each terminal apparatus 30 and the multi-hop communication is used, the optimum value of the transmission control parameter of each terminal apparatus 30 can be changed in accordance with, for example, a data communication path and a modulation or demodulation scheme used in the communication path. These conditions are related to each other. The optimum value of the modulation or demodulation scheme is different for each satellite base station 40 that relays data communication. In the satellite base station 40, the number of terminals (terminal apparatuses 30 or satellite base stations 40) that can be used as relay destinations differs depending on the modulation or demodulation scheme on a transmission side. When an upper limit of the constraint condition is reached, it is necessary to limit the number of terminals relayed by the satellite base station 40. Therefore, in an area of a wireless LAN including the satellite base station 40 (relay terminal), a plurality of control parameters is preferably optimized in consideration of each other.

On the other hand, the data processing apparatus 10 included in the wireless communication system 1B according to the second embodiment repeatedly executes each of the multi-hop communication control parameter optimization process and the transmission control parameter optimization process in the parameter calculation operation in which the constraint condition is considered. Then, a more preferable setting of the transmission control parameter is determined like the first embodiment, and a more preferable setting of the multi-hop communication control parameter is determined. That is, even when the constraint condition related to the transmission control parameter is imposed at the time of using the multi-hop communication, the plurality of related control parameters related to the constraint condition can be more preferably set in terms of the entire network including the individual terminal apparatus 30 in the data processing apparatus 10.

In this way, the wireless communication system 1B according to the second embodiment can change a communication path and a transmission control parameter in accordance with a usage status (for example, an interference status) of each of the base station the satellite base station 40, and the terminal apparatus 30. As a result, the wireless communication system 1 according to the second embodiment can implement stable wireless communication in accordance with a use situation in the entire network.

In addition, the wireless communication system 1B according to the second embodiment can optimize the number of terminals allocated to each of the base station 20 and the satellite base station 40 and can distribute a load on each of the base station and the satellite base station 40. In other words, the wireless communication system 1 according to the second embodiment can inhibit access efficiency from deteriorating due to a large number of terminals connected to each of the base station 20 and the satellite base station 40.

As a result, for example, when the terminal apparatus 30 is an IoT apparatus that transfer a moving image, the wireless communication system 1B according to the second embodiment can inhibit a decrease in the number of connections of the terminal apparatuses 30 capable of moving image transmission in the mesh network. The wireless communication system 1 according to the second embodiment can inhibit a communication area from being shortened due to a shielding object or the like by constructing a mesh network and can expand the communication area.

<3> Others

Various measurement values can be used as the communication quality information QI in the foregoing embodiment. Examples of the measurement values used as the communication quality information QI include a throughput, a data retransmission rate, an RSSI, an error rate, a channel usage rate, a beacon signal reception success rate, an interference status of an overlapping BSS (OBSS), an interference status of another standard, an area limit, and a congestion status of an own BSS. The communication quality information QI collected from the satellite base station may be different from the communication quality information QI collected from the terminal apparatus 30. The communication quality information QI may include a plurality of types of measurement values. A plurality of types of measurement values may be used for each of the determination of a multi-hop communication control parameter and the determination of a transmission control parameter. The positional information of the GPS module may be used to determine the communication path of each of the terminal apparatus 30 and the satellite base station 40. For example, the data processing apparatus 10 refers to the GPS positional information of each terminal apparatus 30 when the number of terminal apparatuses 30 that acquire the communication quality information QI is excessive and it takes time to collect the information. Based on the GPS positional information of each terminal apparatus 30, the data processing apparatus 10 collects communication quality information QI (for example, OBSS information or channel information) transmitted from the plurality of terminal apparatuses 30 at positions close to each other from only a representative small number of terminal apparatuses 30 among the plurality of terminal apparatuses 30 at the close positions. Based on the communication quality information QI collected from a small number of terminal apparatuses 30 selected as representatives, the data processing apparatus 10 changes parameters (for example, a transmission control parameter or a multi-hop communication control parameter) related to communication of the plurality of terminal apparatuses 30 at the close positions. As described above, the data processing apparatus 10 can utilize the GPS positional information for improving information collection efficiency.

For example, when the channel usage rate is measured, the terminal apparatus 30 measures a busy time rate of each channel by carrier sensing (clear channel assessment (CCA) of IEEE 802.11 standard). The busy time rate corresponds to a ratio of a time in which the reception power exceeds a certain threshold. When a reception success rate of a beacon signal is measured, the base station 20 requests the terminal apparatus 30 to measure and notify the communication quality and transmits the beacon signal in a predetermined period. Then, the terminal apparatus 30 measures the number of beacon signals successfully received for the predetermined period and notifies the base station 20 of a measurement result. For example, a channel occupancy time is used to measure the interference situation of the OBSS. For evaluation of the interference situation, a time other than the channel occupancy time may be used. At least a factor that causes the channel in a busy state in a period other than exchange of a signal of the own BSS may be used. For example, magnitude of interference power, interference from another communication system, presence of noise power, or the like may be used to evaluate interference.

In each embodiment, the CPU included in each of the data processing apparatus 10, the base station 20, the terminal apparatus 30, and the satellite base station 40 may be another circuit. For example, each of the data processing apparatus 10, the base station 20, the terminal apparatus 30, and the satellite base station 40 may include a micro processing unit (MPU) or the like instead of the CPU. The process described in each embodiment may be realized by dedicated hardware. The process of each of the data processing apparatus 10, the base station 20, the terminal apparatus 30, and the satellite base station 40 may include a process executed by software and a process executed by hardware in a mixed manner, or may include only one of them.

Each configuration described in the present specification can be rephrased as will be described below. The data processing apparatus 10 may be referred to as a “server” or a “control server”. The base station 20 may be referred to as a “communication base station”, an “access point (AP)”, a “route access point”, a “main router”, a “master access point”, or a “base unit of access point”. The terminal apparatus 30 may be referred to as a “terminal”, a “wireless LAN terminal”, a “wireless station”, an “STA (station)”, or a “wireless apparatus”. The satellite base station 40 may be referred to as a “relay terminal”, a “wireless relay apparatus” a “relay access point”, a “mesh access point (MESH AP)”, a “satellite router”, a “slave access point”, or a “extension unit of access point”. The CPU may be referred to as a “processor”. Each of the ROM, the RAM, and the storage may be referred to as a “storage circuit”. Each of the wireless communication module and the wired communication module may be referred to as a “communication circuit”. When a function of the data processing apparatus 10 is introduced to the base station 20, an operation of the data processing apparatus 10 described in each embodiment is executed by a calculation resource of the base station 20. The calculation resources of the base station 20 are implemented by the CPU 21, the RAM 23, and the like. The “transmission control parameter” may be referred to as a “wireless LAN parameter”.

The present invention is not limited to the foregoing embodiment, and various modifications can be made within the scope of the present invention without departing from the gist of the present invention. The embodiments may be combined appropriately. I that case, the combined effects can be obtained. Further, the foregoing embodiments include various inventions, and various inventions can be extracted by a combination selected from a plurality of disclosed components. For example, even if the problem can be solved and the effect can be obtained despite of deletion of some components from all the components described in the embodiments, the configurations from which the components are deleted can be extracted as the invention.

### REFERENCE SIGNS LIST

1 Wireless communication system
10 Data processing apparatus
20 Base station
30 Terminal apparatus
40 Satellite base station
11, 21, 31, 41 CPU
12, 22, 32, 42 ROM
13, 23, 33, 43 RAM
14 Timer
15, 34 Storage
16 Input interface
17 Wired communication module
24, 36, 45 Wireless communication module
35, 44 GPS module
101, 201 Wired signal processing unit
102, 202, 302 Data processing unit
103 Filtering unit
104 Storage unit
105 Operation software execution unit
106 Control unit
107 Calculation unit
108 Command library
110 Transmission constraint information
111 Apparatus management information
112 Communication quality information
203, 303, 403 Application execution unit
204, 304, 404 Wireless LAN control unit
205, 301, 401 Wireless signal processing unit

1: A data processing apparatus comprising:
a signal processing unit configured to receive data wirelessly transmitted from a terminal apparatus; and
a control unit configured to execute a first operation of determining a transmission control parameter used for wireless communication of the terminal apparatus and repeatedly determining a transmission control parameter again using the determined transmission control parameter under a constraint condition related to the wireless communication of the terminal apparatus when the determined transmission control parameter is different from a transmission control parameter before the determination, and apply the transmission control parameter obtained through the first operation to the terminal apparatus.

2: The data processing apparatus according to claim 1,
wherein the control unit is configured to:
execute, under the constraint condition, a second operation of determining a multi-hop communication control parameter related to a communication path of the terminal apparatus, executing the first operation after the determination of the multi-hop communication control parameter, determining a multi-hop communication control parameter again using the transmission control parameter obtained through the first operation when the transmission control parameter obtained through the first operation is associated with the multi-hop communication control parameter after the first operation, and repeatedly executing the first operation again using the multi-hop communication control parameter determined again, and apply the multi-hop communication control parameter obtained through the second operation to the terminal apparatus.

3: The data processing apparatus according to claim 1,
wherein the control unit is configured to use communication information of the terminal apparatus collected from the terminal apparatus when the transmission control parameter is determined again.

4: The data processing apparatus according to claim 3,
wherein the control unit is configured to collect the communication information of the terminal apparatus from the terminal apparatus based on a change in a first control parameter among transmission control parameters in the first operation, and use the collected communication information of the terminal apparatus to determine a subsequent transmission control parameter.

5: The data processing apparatus according to claim 1,
wherein the constraint condition includes a time in which the terminal apparatus is able to transmit and which is determined based on a transmission time ratio by law.

6: A data processing method comprising:
executing a first operation of determining a transmission control parameter used for wireless communication of a terminal apparatus under a constraint condition related to the wireless communication of the terminal apparatus, and repeatedly determining the transmission control parameter again using the determined transmission control parameter when the determined transmission control parameter is different from the transmission control parameter before the determination; and
applying the transmission control parameter obtained through the first operation to the terminal apparatus.

7: The data processing method according to claim 6, further comprising:
executing, under the constraint condition, a second operation of determining a multi-hop communication control parameter related to a communication path of the terminal apparatus, executing the first operation after the determination of the multi-hop communication control parameter, determining a multi-hop communication control parameter again using the transmission control parameter obtained through the first operation when the transmission control parameter obtained through the first operation is associated with the multi-hop communication control parameter after the first operation, and repeatedly executing the first operation again using the multi-hop communication control parameter determined again; and
applying the multi-hop communication control parameter obtained through the second operation to the terminal apparatus.

8: A non-transitory computer readable medium storing a computer program which is executed by a computer to provide the steps of:
execute a first operation of determining a transmission control parameter used for wireless communication of a terminal apparatus under a constraint condition related to the wireless communication of the terminal apparatus, and repeatedly determining the transmission control parameter again using the determined transmission control parameter when the determined transmission control parameter is different from the transmission control parameter before the determination; and
apply the transmission control parameter obtained through the first operation to the terminal apparatus.

9: The non-transitory computer readable medium according to claim 8, further causing the computer to provide the steps of:
execute, under the constraint condition, a second operation of determining a multi-hop communication control parameter related to a communication path of the terminal apparatus, executing the first operation after the determination of the multi-hop communication control parameter, determining a multi-hop communication control parameter again using the transmission control parameter obtained through the first operation when the transmission control parameter obtained through the first operation is associated with the multi-hop communication control parameter after the first operation, and repeatedly executing the first operation again using the multi-hop communication control parameter determined again; and
apply the multi-hop communication control parameter obtained through the second operation to the terminal apparatus.
